(19) United States
(12) Patent Application Publication
(10) Pub. No.: US 2006/0219979 A1
(43) Pub. Date: Oct. 5, 2006

(54) Method of increasing the oxidation stability of biodiesel

(75) Inventors: Hark-Oluf Asbahr, Gonnheim (DE); Thomas Bomba, Rodersheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 11/396,472

(22) Filed: Apr. 4, 2006

(30) Foreign Application Priority Data
Apr. 4, 2005 (DE) 10 2005 015 475.1

(51) Int. Cl. C09K 15/04

(52) U.S. Cl. 252/399

(57) ABSTRACT

A method of increasing the oxidation stability of biodiesel, by addition of at least one primary antioxidant of formula I 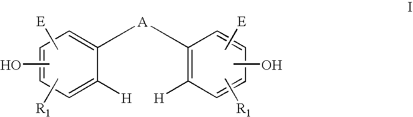 to the biodiesel to be stabilized, in an amount of from 10 to 20 000 ppm (w/w); a biodiesel stabilized by the at least one primary antioxidant of the formula I; and a method of preventing corrosion, blockages in injection pumps, blockages in fuel lines, or a combination thereof, in engines, heaters, or machines utilizing biodiesel as a fuel source, the method being adding the compound of formula I to the biodiesel of the engines, heaters, or machines.

### CROSS REFERENCES TO RELATED APPLICATIONS

This application claims priority to German Patent Application No. 102005015475.1, filed Apr. 4, 2005, which is incorporated herein by reference in its entirety.

### BACKGROUND OF THE INVENTION

1. Field of the Invention

The present invention relates to a method of increasing the oxidation stability of biodiesel.

2. Discussion of the Background

Biodiesel is an alternative to conventional diesel fuel, and the use of biodiesel continues to increase. Biodiesel comprises monoalkyl esters of vegetable oils, animal fats and used cooking fats. Biodiesel is obtained by transesterification of oils with an alcohol in the presence of a catalyst. Examples of oils that can be transesterified with an alcohol to form biodiesel include rapeseed oil, soybean oil, sunflower oil and used cooking oils.

In recent years, biodiesel production has increased significantly because biodiesel is useful as an alternative passenger car fuel, as a heating fuel, and as an engine fuel. Biodiesel however, has a high content of unsaturated fatty acid esters which can easily be oxidized by atmospheric oxygen. The products formed from oxidation of biodiesel (e.g, acids and resins) can lead to corrosion and blockages in injection pumps and/or fuel lines in engines, heaters, and/or machines (such as generators) which utilize biodiesel as a fuel source. Thus, there is a need for oxidation-stabilized biodiesel.

2,6-di-tert-butyl-4-methylphenol (BHT), an antioxidant, has been added to biodiesel in an attempt to meet the oxidation stability requirements of the standard DIN EN 14214.

European patent EP 0 189 049, describes that 2,6-di-tert-butyl-4-methylphenol, in amounts of from 10 to 100 ppm, can be used to stabilize palm kernel oil methyl esters. The methyl-esters of the palm kernel oil have from 12 to 18 carbon atoms in the fatty acid portion of the esters.

DE 102 52 714 and WO 2004/044104 describe a method of increasing the oxidation stability of biodiesel by addition of a monoalkylhydroxytoluene or a dialkylhydroxytoluene. A stock solution is prepared which contains, from 15 to 60% by weight, of the mono or dialkylhydroxytoluene dissolved in biodiesel. The stock solution is then added to un-stabilized biodiesel to give a stabilized biodiesel that has a concentration of, from 0.005 to 2% by weight, of the mono or dialkylhydroxytoluene.

DE 102 52 715 describes a method of increasing the storage stability of biodiesel by addition, to the biodiesel, of 2,4-di-tert-butylhydroxytoluene. A liquid biodiesel stock solution is prepared which contains from 15 to 60% by weight of dissolved 2,4-di-tert-butyl-hydroxytoluene. The liquid stock solution is then added to the un-stabilized biodiesel to give a stabilized biodiesel solution with a concentration of from 0.005 to 2%, by weight, of 2,4-di-tert-butylhydroxytoluene.

However, none of these methods for stabilizing biodiesel is entirely satisfactory, because, among other things, relatively high levels antioxidant are required stabilize the biodiesel during storage.

### SUMMARY OF THE INVENTION

It is, therefore, an object of the present invention to provide an improved method of increasing the oxidation stability of biodiesel.

Another object of the invention is to discover a primary antioxidant that is superior to antioxidants previously utilized to impart oxidation stability to biodiesel.

An additional object of the invention is to find a novel antioxidant to stabilize biodiesel wherein a smaller amount of this novel antioxidant, when compared to antioxidants previously utilized, is required to stabilze biodiesel.

These and other objects, which will become apparent during the following detailed description, have been achieved by the inventors' discovery that the addition of primary antioxidants, based on substituted bisphenols, to biodiesel, effects a significant improvement in the oxidation stability of the biodiesel.

### DETAILED DESCRIPTION OF THE PREFERRED EMBODIMENTS

The present invention provides a method of increasing the oxidation stability of biodiesel, which comprises adding at least one primary antioxidant having the structure of formula I

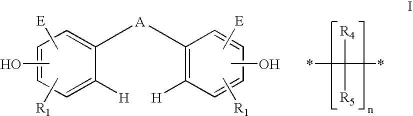

wherein A=or —S—;

wherein n=1 to 5;

wherein E, is a methyl radical, a tert-butyl radical,

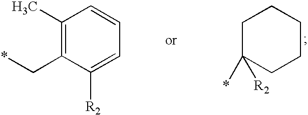

wherein each E may be the same or different;

wherein each of R₁, R₄ and R₅, may, independently, be the same or different, and are hydrogen or an alkyl group; and

wherein each R₂ is, independently, a hydrogen or a methyl group; to the un-stabilized biodiesel, in an amount of from 10 to 20,000 ppm (w/w).

The invention further provides for the use of compounds having the structure I as primary antioxidant for increasing the oxidation stability of biodiesel.

The invention likewise provides an oxidation-stabilized biodiesel which contains from 10 to 20,000 ppm (w/w) of at least one primary antioxidant of the formula I.

In the inventive method of increasing the oxidation stability of biodiesel, at least one primary antioxidant of formula I is added to the biodiesel to be stabilized in an amount of from 10 to 20,000 ppm (w/w), or of from 50 to 12,000 ppm (w/w), or of from 100 to 8,000 ppm (w/w). In the method of the invention, it is possible to use at least one primary antioxidant of the structure I which has an alkyl group having from 1 to 20 carbon atoms, or from 1 to 10 carbon atoms, as the alkyl group in the substituent of the type R₁. The alkyl group of the substituent of the type R₁ can be either linear or branched.

The symbol * in the definition of a substituent of the type E and of the type A in formula I represents a carbon atom of an aromatic ring system of formula I.

For the purposes of the present invention, primary antioxidants are compounds or mixtures of compounds which inhibit or prevent oxidative changes in biodiesel. While not bound by theory, the mode of action of these primary antioxidants in the biodiesel is believed to be described in the following reaction scheme, where R and R′ are each an organic radical and AOH is a primary antioxidant used in the method of the invention.

1. Chain Initiation
R→H→R*+H*
R—H+O₂→R*+HO₂*
2. Chain Propagation
R*+O₂→RO_{2*}
RO₂*+R′—H→ROOH+R′*
3. Chain Termination
RO₂*+AOH→ROOH+AO*
AO*+R*→AOR

Apart from the abovementioned reactions, it is also possible for reactions on the double bonds of the alkyl esters of fatty acids, which can likewise be initiated by oxygen, to occur. Also, the carbon-hydrogen bond which is located in the allyl position relative to the double bond can be attacked by oxygen:

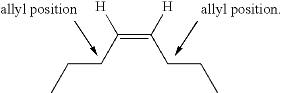

In an additional embodiment, the at least one primary antioxidant of formula I has the structure of formula II:

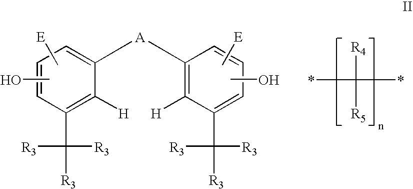

wherein A=or —S—;

wherein n=1 to 5;

wherein E is a methyl radical, a tert-butyl radical,

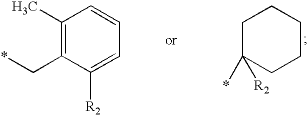

wherein each E may be the same or different;

wherein each of R₃, R₄ and R₅, may, independently, be the same or different, and are hydrogen or an alkyl group; and

wherein each R₂ is, independently, a hydrogen or a methyl group; is added according to the method of the invention.

In a further embodiment, the at least one primary antioxidant of formula I has the structure of formula III:

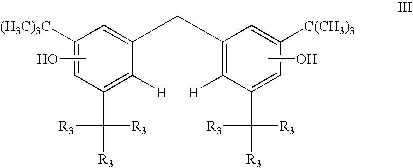

wherein each of R₃ is, independently, a hydrogen or a methyl group; according to the method of the invention.

In yet another embodiment of the invention, the at least one primary antioxidant having the structure of formulae I, II or III comprises two identically substituted phenyl structures.

In a further embodiment of the method of the invention, at least one compound selected from among 2,2′-ethylidenebis[4,6-di-tert-butylphenol], 2,2′-ethylidenebis[6-tert-butyl-4-isobutylphenol], 2,2′-isobutylidenebis[4,6-dimethylphenol], 2,2′-methylenebis[4,6-di-tert-butylphenol], 2,2′-methylenebis[4-methyl-6-(α-methylcyclohexyl)phenol], 2,2′-methylenebis[6-cyclohexyl-4-methylphenol], 2,2′-methylenebis[6-(α,α′-dimethylbenzyl)-4-nonylphenol], 2,2′-methylenebis[6-(α-methylbenzyl)-4-nonylphenol], 2,2′-methylenebis[4-methyl-6-nonylphenol], 2,2′-methylenebis[6-tert-butyl-4-ethylphenol], 2,2′-methylenebis[6-tert-butyl-4-methylphenol], 2,2′-thiobis[6-tert-butyl-4-methylphenol], 4,4′-butylidenebis[2-tert-butyl-5-methylphenol], 4,4′-methylenebis[2,6-di-tert-butylphenol], 4,4′-methylenebis[6-tert-butyl-2-methylphenol], 4,4′-thiobis[2-tert-butyl-5-methylphenol]and/or 4,4′-isopropylidenediphenol can be added as primary antioxidant to the biodiesel.

In an additional embodiment of the invention, 4,4′-methylenebis[2,6-di-tert-butylphenol](formula IV) is added as the primary antioxidant to the biodiesel.

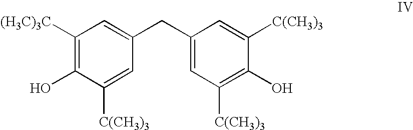

In a further embodiment of the invention, 2,2′-methylenebis[6-tert-butyl-4-methylphenol] (formula V) as the primary antioxidant, is added to the biodiesel.

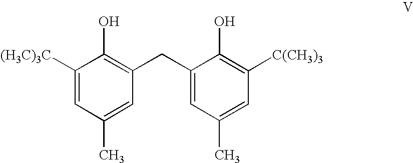

One of the compounds having the formulae I to V can be used individually, as the primary antioxidant or, a mixture of various compounds having the structures of formulae I to V may be utilized as the primary antioxidant.

According to the method of the invention, secondary antioxidants can be used, either as pure substances or as a mixture of various secondary antioxidants, in addition to the primary antioxidants having the formulae I to V. For the purposes of the present invention, secondary antioxidants are compounds which are able to reduce and therefore degrade hydroperoxide groups directly without new free radicals being formed.

Secondary antioxidants which can be used according to the method of the invention are alkylthiomethylphenols, some examples of which are:
2,4-di((octylthio)methyl)-6-tert-butylphenol,
2,4-di((octylthio)methyl)-6-methylphenol,
2,4-di((octylthio)methyl))-6-ethylphenol and
2,6-di((dodecylthio)methyl)-4-nonylphenol.
   Hydroxylated diphenyl thioethers are also useful as secondary antioxidants. Some examples include:
2,2′-thiobis[6-tert-butyl-4-methylphenol],
2,2′-thiobis[4-octylphenol],
4,4′-thiobis[6-tert-butyl-3-methylphenol],
4,4′-thiobis[6-tert-butyl-2-methylphenol],
4,4′-thiobis[3,6-di-sec-amylphenol] and
4,4′-bis[2,6-dimethyl-4-hydroxyphenyl]disulfide.

Phosphites or phosphonites can also be employed as secondary antioxidants. Some examples of phosphates and phosphonites which can be employed include:
triphenyl phosphite,
diphenyl alkyl phosphites,
phenyl dialkyl phosphites,
tris[nonylphenyl]phosphite,
trilauryl phosphite,
trioctadecyl phosphite,
distearyl pentaerythrityl diphosphite,
tris[2,4-di-tert-butylphenyl]phosphite,
diisodecyl pentaerythrityl diphosphite,
bis[2,4-di-tert-butylphenyl]pentaerythrityl diphosphite,
bis[2,6-di-tert-butyl-4-methylphenyl]pentaerythrityl diphosphite,
bis[isodecyloxy]pentaerythrityl diphosphite,
bis[2,4-di-tert-butyl-6-methylphenyl]pentaerythrityl diphosphite,
bis[2,4,6-tri-tert-butylphenyl]pentaerythrityl diphosphite,
tristearyl sorbitol triphosphite,
tetrakis[2,4-di-tert-butylphenyl]4,4′-biphenylenediphosphonite,
6-isooctyloxy-2,4,8,10-tetra-tert-butyl-12H-dibenzo[d,g]-1,3,2-dioxaphosphocine,
6-fluoro-2,4,8,10-tetra-tert-butyl-12-methyldibenzo[d,g]-1,3,2-dioxaphosphocine,
bis[2,4-di-tert-butyl-6-methylphenyl]methyl phosphite and
bis[2,4-di-tert-butyl-6-methylphenyl]ethyl phosphate.

Peroxide-destroying compounds can also be used as secondary antioxidants, some examples of which include:

esters of β-thiodipropionic acid, such as the lauryl, stearyl, myristyl or tridecyl esters,

mercaptobenzimidazole,

the zinc salt of 2-mercaptobenzimidazole,

zinc dibutyldithiocarbamate,

dioctadecyl disulfide and

pentaerythrityl tetrakis[β-dodecylmercapto]propionate.

Mixtures of any of the above secondary antioxidants may also be employed.

For the purposes of the present invention, the term biodiesel encompasses all the saturated and/or unsaturated alkyl esters of fatty acids, in particular methyl or ethyl esters of fatty acids, which can be used as energy carriers. For the purposes of the present invention, energy carriers include both fuels as sources of heat, for example heating material, and fuels for powering vehicles, for example automobiles, goods vehicles, ships or aircraft. The biodiesel to which the method of the invention is applied is preferably a biodiesel which is usually marketed under the name BIODIESEL for use as automobile fuel. In particular, the biodiesel to which the method of the invention is applied comprises C₁₂-C₂₄ fatty acid alkyl esters, C₁₂-C₂₄ fatty acid methyl esters or C₁₂-C₂₄ fatty acid ethyl esters, which can be present in pure form or as a mixture. In addition, the biodiesel to which the method of the invention is applied can further comprise all customary additives such as secondary antioxidants, antifoams, and low-temperature flow improvers, in addition to comprising at least one primary antioxidant.

The method of the invention can be applied to biodiesel produced from vegetable and/or animal oils by a process of transesterification with an alcohol, such as methanol or ethanol. The method of the invention is also applied to biodiesel comprising transesterification products of rapeseed oil, soybean oil, sunflower oil, palm kernel oil, coconut oil, jatropha oil, cotton seed oil, peanut oil, maize oil and/or used cooking oils. The method of the invention can also be applied to mixtures of the transesterification products of various vegetable and/or animal oils.

In a particular embodiment of the method of the invention, mixtures (also known as blends) of saturated and/or unsaturated fatty acid alkyl esters, which can also be in the form of mixtures of various fatty acid alkyl esters, with liquid energy carriers, for example mineral diesel fuel or heating oil, can be used as biodiesel. A mixture of mineral diesel fuel of from 0.1 to 99.9% by volume, or of from 1 to 50% by volume, or of from 2 to 25% by volume, of saturated and/or unsaturated fatty acid alkyl esters can be utilized. In a subsequent step of the method of the invention, the oxidation-stabilized biodiesel (stabilized by addition of at least one primary antioxidant and, optionally, any additional additives) can be added in an amount of from 0.1 to 99.9% by volume, or of from 1 to 50% by volume, or of from 2 to 25% by volume, to a liquid energy carrier, in particular a mineral diesel fuel or heating oil.

According to the method of the invention, the primary antioxidants can be added as solid in an amount of from 10 to 20,000 ppm (w/w), or from 50 to 12,000 ppm (w/w), or from 100 to 8,000 ppm (w/w), to the biodiesel. Secondary antioxidants can also be added in an amount of from 10 to 20,000 ppm (w/w), or of from 50 to 12,000 ppm (w/w), or of from 100 to 8,000 ppm (w/w), to the biodiesel.

The primary antioxidants are preferably dissolved in the biodiesel with stirring at a temperature of from 18° C. to 60° C., or of from 20° C. to 25° C.

In a particular embodiment of the method of the invention, the primary antioxidants are dissolved in biodiesel to produce a masterbatch before addition of the masterbatch to the energy-carrier biodiesel. For this purpose, initially from 10 to 80% by weight, or from 15 to 70% by weight, or from 20 to 60% by weight, of the primary antioxidant is dissolved in biodiesel. This masterbatch can subsequently be added to the energy carrier biodiesel, with stirring at a temperature of from 18° C. to 60° C., or of from 20° C. to 25° C.

To achieve dust-free handling of the primary antioxidants in the method of the invention, a composition comprising the primary antioxidants and an oil, in particular mineral oil, biodiesel or oil as is used for the production of the biodiesel to which the method of the invention is applied, can be added to the biodiesel. This composition can comprise from 0.1 to 25% by weight, or from 1 to 10% by weight, of the oil.

In a further embodiment of the method of the invention, the primary antioxidants are dissolved in at least one organic solvent, such as an alcohol, or an aromatic solvent, before addition to the biodiesel. For this purpose, initially from 10 to 60% by weight, or from 15 to 50% by weight, or from 20 to 40% by weight, of the primary antioxidants are dissolved in the alcohol or aromatic solvent. Ethanol, n-propanol, isopropanol, n-butanol, isobutanol, toluene, or xylene can be used as the alcohol or aromatic solvent. The solution of the primary antioxidants can subsequently be added to the energy carrier biodiesel, preferably with stirring at a temperature of from 18° C. to 60° C., or of from 20° C. to 25° C.

The invention further provides for the use of compounds of formula I as primary antioxidants for increasing the oxidation stability of biodiesel.

Within formula I, compounds of formula II, and compounds of formula III, can also be used in as primary antioxidants according to the invention. In another embodiment of the invention, at least one compound having the structure of formulae I, II or m wherein the two substituted phenyl structures are identical, is utilized as the primary antioxidant.

In a further embodiment of the invention, at least one compound selected from among 2,2′-ethylidenebis[4,6-di-tert-butylphenol], 2,2′-ethylidenebis[6-tert-butyl-4-isobutylphenol], 2,2′-isobutylidenebis[4,6-dimethylphenol], 2,2′-methylenebis[4,6-di-tert-butylphenol], 2,2′-methylenebis[4-methyl-6-(α-methylcyclohexyl)phenol], 2,2′-methylenebis[6-cyclohexyl-4-methylphenol], 2,2′-methylenebis[6-(α,α-dimethylbenzyl)-4-nonylphenol], 2,2′-methylenebis[6-(α-methylbenzyl)-4-nonylphenol], 2,2′-methylenebis[4-methyl-6-nonylphenol], 2,2′-methylenebis[6-tert-butyl-4-ethylphenol], 2,2′-methylenebis[6-tert-butyl-4-methylphenol], 2,2′-thiobis[6-tert-butyl-4-methylphenol], 4,4′-butylidenebis[2-tert-butyl-5-methylphenol], 4,4′-methylenebis[2,6-di-tert-butylphenol], 4,4′-methylenebis[6-tert-butyl-2-methylphenol], 4,4′-thiobis[2-tert-butyl-5-methylphenol]and/or 4,4′-isopropylidenediphenol is used as the primary antioxidant.

The invention likewise provides an oxidation-stabilized biodiesel which comprises from 10 to 20,000 ppm (w/w), or from 50 to 12,000 ppm (w/w), of from 100 to 8,000 ppm (w/w), of at least one primary antioxidant having the structure of formula I.

In another embodiment of the invention, the biodiesel of the invention comprises at least one primary antioxidant having the structure of formula II, or at least one primary antioxidant having the structure of formula III.

In an additional embodiment of the invention, the biodiesel comprises at least one primary antioxidant having the structure of formulae I, II, or III wherein the two substituted phenyl structures are identical.

In a further embodiment of the present invention, the biodiesel comprises at least one primary antioxidant selected from among: 2,2′-ethylidenebis[4,6-di-tert-butylphenol], 2,2′-ethylidenebis[6-tert-butyl-4-isobutylphenol], 2,2′-isobutylidenebis[4,6-dimethylphenol], 2,2′-methylenebis[4,6-di-tert-butylphenol], 2,2′-methylenebis[4-methyl-6-(α-methylcyclo-hexyl)phenol], 2,2′-methylenebis[6-cyclohexyl-4-methylphenol], 2,2′-methylenebis[6-(α,α′-dimethylbenzyl)-4-nonylphenol], 2,2′-methylenebis[6-(α-methylbenzyl)-4-nonylphenol], 2,2′-methylenebis[4-methyl-6-nonylphenol], 2,2′-methylenebis[6-tert-butyl-4-ethylphenol], 2,2′-methylenebis[6-tert-butyl-4-methylphenol], 2,2′-thiobis[6-tert-butyl-4-methylphenol], 4,4′-butylidenebis[2-tert-butyl-5-methylphenol], 4,4′-methylenebis[2,6-di-tert-butylphenol], 4,4′-methylenebis[6-tert-butyl-2-methylphenol], 4,4′-thiobis[2-tert-butyl-5-methylphenol]and/or 4,4′-isopropylidenediphenol.

The biodiesel of the invention can comprise either a compound having one of the structures of formulae I to V as a pure substance or a mixture of various compounds having the structures of formulae I to V as the primary antioxidant.

The biodiesel of the present invention can comprise C₁₂-C₂₄ fatty acid alkyl esters, preferably C₁₂-C₂₄ fatty acid methyl esters or C₁₂-C₂₄ fatty acid ethyl esters, which can be present in pure form or as a mixture. In addition, the biodiesel of the invention can further comprise all customary additives such as secondary antioxidants and antifoams. The biodiesel of the invention comprises transesterification products of rapeseed oil, soybean oil, sunflower oil, palm kernel oil, coconut oil, jatropha oil and/or used cooking oils. The biodiesel of the invention can also comprise mixtures of transesterification products of various vegetable and/or animal oils.

In addition, the biodiesel of the invention can further comprise all customary additives such as secondary antioxidants, antifoams, low-temperature flow improvers. Secondary antioxidants which can be present in the biodiesel of the invention include alkylthio-methylphenols, some examples of which are:
2,4-di((octylthio)methyl)-6-tert-butylphenol,
2,4-di((octylthio)methyl)-6-methylphenol,
2,4-di((octylthio)methyl)-6-ethylphenol and
2,6-di((dodecylthio)methyl)-4-nonylphenol.

Hydroxylated diphenyl thioethers can also be employed as secondary antioxidants in the biodiesel of the present invention. Some examples of hydroxylated diphenyl thioethers are:
2,2′-thiobis[6-tert-butyl-4-methylphenol],
2,2′-thiobis[4-octylphenol],
4,4′-thiobis[6-tert-butyl-3-methylphenol],
4,4′-thiobis[6-tert-butyl-2-methylphenol],
4,4′-thiobis[3,6-di-sec-amylphenol]and
4,4′-bis[2,6-dimethyl-4-hydroxyphenyl]disulfide.

Phosphites or phosphonites, can also be employed as secondary antioxidants of the present invention. Some examples include:
triphenyl phosphite,
diphenyl alkyl phosphites,
phenyl dialkyl phosphites,
tris[nonylphenyl]phosphite,
trilauryl phosphite,
trioctadecyl phosphite,
distearyl pentaerythrityl diphosphite,
tris[2,4-di-tert-butylphenyl]phosphite,
diisodecyl pentaerythrityl diphosphite,
bis[2,4-di-tert-butylphenyl]pentaerythrityl diphosphite,
bis[2,6-di-tert-butyl-4-methylphenyl]pentaerythrityl diphosphite,
bis[isodecyloxy]pentaerythrityl diphosphite,
bis[2,4-di-tert-butyl-6-methylphenyl]pentaerythrityl diphosphite,
bis[2,4,6-tri-tert-butylphenyl]pentaerythrityl diphosphite,
tristearyl sorbitol triphosphite,
tetrakis[2,4-di-tert-butylphenyl]4,4′-biphenylenediphosphonite,
6-isooctyloxy-2,4,8,10-tetra-tert-butyl-12H-dibenzo[d,g]-1,3,2-dioxaphosphocine,
6-fluoro-2,4,8,10-tetra-tert-butyl-12-methyldibenzo[d,g]-1,3,2-dioxaphosphocine,
bis[2,4-di-tert-butyl-6-methylphenyl]methyl phosphite and
bis[2,4-di-tert-butyl-6-methylphenyl]ethyl phosphate.

Peroxide-destroying compounds can also be employed as secondary antioxidants in the biodiesel of the present invention. Some examples include:

esters of group β-thiodipropionic acid, such as lauryl, stearyl, myristyl or tridecyl esters,

mercaptobenzimidazole,

the zinc salt of 2-mercaptobenzimidazole,

zinc dibutyldithiocarbamate,

dioctadecyl disulfide and

pentaerythrityl tetrakis[β-dodecylmercapto]propionate, or mixtures of these compounds.

The secondary antioxidants can be present in an amount of from 10 to 20,000 ppm (w/w), or of from 50 to 12,000 ppm (w/w), or of from 100 to 8,000 ppm (w/w), in the biodiesel of the invention.

The biodiesel of the invention is preferably produced using the method of the invention.

### EXAMPLES

The present invention is described by way of example in the examples hereinafter. Obviously, numerous modifications and variations of the present invention are possible in light of the above teachings. It is therefore to be understood that, within the scope of the appended claims, the invention may be practiced otherwise than as specifically described herein.

### Example 1

In a glass beaker, the primary antioxidant is dissolved in biodiesel at 20° C. with stirring, and stirring is continued until a clear solution is obtained. The antioxidants used, the biodiesel used and the ratios are shown in Table 1.

### Example 2

The oxidation stability of the samples produced as described in Example 1 was examined at a test temperature of 110° C. in accordance with the test method DIN EN 14112.

### Example 3

TABLE 1

| | | |
|---|---|---|
| | Amount of | Oxidation |
| | anti- | stability |
| | oxidant | [in h at |
| Antioxidant | [in ppm] | 110° C.] |

Rapeseed oil methyl ester

| | | |
|---|---|---|
| — | — | 5.1 |
| 4,4′-Methylenebis[2,6-di-tert-butylphenol]¹ | 500 | 8.0 |
| 2,6-Di-tert-butyl-4-methylphenol² | 500 | 7.1 |

Used cooking fat methyl ester

| | | |
|---|---|---|
| — | — | 4.0 |
| 2,2′-Methylenebis[6-tert-butyl-4-methylphenol]³ | 2000 | 19.8 |
| 4,4′-Methylene[2,6-di-tert-butylphenol]¹ | 2000 | 17.1 |
| 2,6-Di-tert-butyl-4-methylphenol² | 2000 | 12.0 |

Soybean oil methyl ester

| | | |
|---|---|---|
| — | — | 3.5 |
| 2,2′-Methylenebis[6-tert-butyl-4-methylphenol]³ | 2000 | 12.0 |
| 4,4′-Methylenebis[2,6-di-tert-butylphenol]¹ | 2000 | 10.9 |
| 2,6-Di-tert-butyl-4-methylphenol² | 2000 | 8.2 |

Sunflower oil methyl ester

| | | |
|---|---|---|
| — | — | 1.6 |
| 2,2′-Methylenebis[6-tert-butyl-4-methylphenol]³ | 4000 | 13.0 |
| 4,4′-Methylenebis[2,6-di-tert-butylphenol]¹ | 4000 | 12.8 |
| 2,6-Di-tert-butyl-4-methylphenol² | 4000 | 9.0 |

¹procured from Degussa under the trade name IONOL 220
²procured from Degussa under the trade name IONOL CP
³procured from Degussa under the trade name IONOL 46

The above written description of the invention provides a manner and process of making and using it such that any person skilled in this art is enabled to make and use the same, this enablement being provided in particular for the subject matter of the appended claims, which make up part of the original description.

As used above, the phrases “selected from the group consisting of,” “chosen from,” and the like include mixtures of the specified materials.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out. Terms such as “contain(s)” and the like as used herein are open terms meaning “including at least” unless otherwise specifically noted.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A method of increasing the oxidation stability of biodiesel, comprising adding at least one primary antioxidant having the structure of formula I 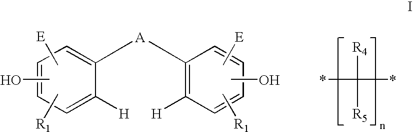
wherein A=or —S—;
wherein n=1 to 5;
wherein E is a methyl methyl radical, a tert-butyl radical, 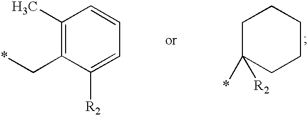
wherein each E may be the same or different;
wherein each of R₁, R₄ and R₅ may, independently, be the same or different and are hydrogen or an alkyl group; and
wherein each R₂ is, independently, a hydrogen or a methyl group;
to the biodiesel to be stabilized in an amount of from 10 to 20,000 ppm (w/w).

2. The method of claim 1, wherein the at least one primary antioxidant is dissolved in at least one organic solvent before addition to the biodiesel.

3. The method of claim 2, wherein the at least one organic solvent is selected from the group consisting of ethanol, n-propanol, isopropanol, n-butanol, isobutanol, toluene, xylene, and mixtures thereof.

4. The method of claim 1, wherein the at least one primary antioxidant is dissolved in biodiesel to produce a masterbatch followed by the addition of at least a part of the masterbatch to the biodiesel.

5. The method of claim 1, wherein the at least one primary antioxidant has the structure of formula II 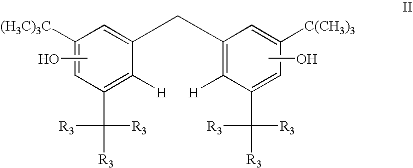
wherein each R₃, is, independently, hydrogen or a methyl group.

6. The method of claim 5, wherein the at least one primary antioxidant is 4,4′-methylenebis[2,6-di-tert-butylphenol].

7. The method of claim 5, wherein the at least one primary antioxidant is 2,2′-methylenebis[6-tert-butyl-4-methylphenol].

8. The method of claim 1, further comprising adding at least one additive to the biodiesel.

9. The method of claim 8, wherein the at least one additive is selected from the group consisting of at least one secondary antioxidant, at least one antifoam, at least one low-temperature flow improver, and combinations thereof.

10. The method of claim 1, further comprising adding at least one secondary antioxidant wherein the at least one secondary antioxidant is selected from the group consisting of alkylthiomethylphenols, hydroxylated diphenyl thioethers, phosphates, phosphonites, peroxide-destroying compounds, and mixtures thereof.

11. The method of claim 1, further comprising adding at least one secondary antioxidant wherein the at least one secondary antioxidant is selected from the group consisting of 2,4-di((octylthio)methyl)-6-tert-butylphenol, 2,4-di((octylthio)methyl)-6-methylphenol, 2,4-di((octylthio)methyl))-6-ethylphenol, 2,6-di((dodecylthio)methyl)-4-nonylphenol, 2,2′-thiobis[6-tert-butyl-4-methylphenol], 2,2′-thiobis[4-octylphenol], 4,4′-thiobis[6-tert-butyl-3-methylphenol], 4,4′-thiobis[6-tert-butyl-2-methylphenol], 4,4′-thiobis[3,6-di-sec-amylphenol], 4,4′-bis[2,6-dimethyl-4-hydroxyphenyl]disulfide, triphenyl phosphite, diphenyl alkyl phosphites, phenyl dialkyl phosphites, tris[nonylphenyl]phosphite, trilauryl phosphite, trioctadecyl phosphite, distearyl pentaerythrityl diphosphite, tris[2,4-di-tert-butylphenyl]phosphite, diisodecyl pentaerythrityl diphosphite, bis[2,4-di-tert-butylphenyl]pentaerythrityl diphosphite, bis[2,6-di-tert-butyl-4-methylphenyl]pentaerythrityl diphosphite, bis[isodecyloxy]pentaerythrityl diphosphite, bis[2,4-di-tert-butyl-6-methylphenyl]pentaerythrityl diphosphite, bis[2,4,6-tri-tert-butylphenyl]pentaerythrityl diphosphite, tristearyl sorbitol triphosphite, tetrakis[2,4-di-tert-butylphenyl]4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyldibenzo[d,g]-1,3,2-dioxaphosphocine, bis[2,4-di-tert-butyl-6-methylphenyl]methyl phosphate, bis[2,4-di-tert-butyl-6-methylphenyl]ethyl phosphate, esters of β-thiodipropionic acid, mercaptobenzimidazole, the zinc salt of 2-mercaptobenzimidazole, zinc dibutyldithiocarbamate, dioctadecyl disulfide, pentaerythrityl tetrakis[β-dodecylmercapto]propionate, and mixtures thereof.

12. The method of claim 1, wherein when the at least one primary antioxidant is added to the biodiesel, the temperature of the biodiesel is from 18° C. to 60° C.

13. A method of preventing corrosion, blockages in injection pumps, blockages in fuel lines, or a combination thereof, in engines, heaters, or machines utilizing biodiesel as a fuel source, comprising
adding at least one primary antioxidant comprising at least one compound having the structure of formula I 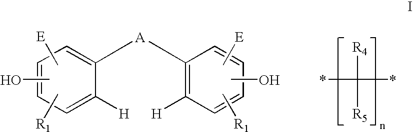
wherein A=or —S—;
wherein n=to S;
wherein E is a methyl radical, a tert-butyl radical, 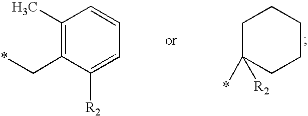
wherein each E may be the same or different;
wherein each of R¹, R⁴ and R₅ may, independently, be the same or different and are hydrogen or an alkyl group; and
wherein each R₂ is, independently, a hydrogen or a methyl group;
to biodiesel located in an engine, heater, or machine.

14. An oxidation-stabilized biodiesel comprising from 10 to 20,000 ppm (w/w) of at least one primary antioxidant having the structure of formula I 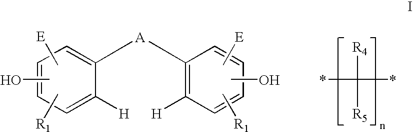
wherein A=or —S—;
wherein n=1 to 5;
wherein E is a methyl radical, a tert-butyl radical, 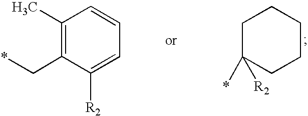
wherein each E may be the same or different;
wherein each of R₁, R₄ and R₅ may, independently, be the same or different and are hydrogen or an alkyl group; and
wherein each R₂ is independently, a hydrogen or a methyl group.

15. The oxidation-stabilized biodiesel of claim 14, wherein the at least one primary antioxidant has the structure of formula II 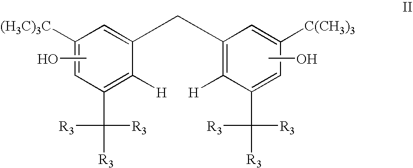
wherein each R₃, is, independently, hydrogen or a methyl group.

16. The oxidation-stabilized biodiesel of claim 14, wherein the at least one primary antioxidant is 4,4′-methylenebis[2,6-di-tert-butylphenol].

17. The oxidation-stabilized biodiesel of claim 14, wherein the at least one primary antioxidant is 2,2′-methylenebis[6-tert-butyl-4-methylphenol].

18. The oxidation-stabilized biodiesel of claim 14, further comprising at least one additive.

19. The oxidation-stabilized biodiesel of claim 14, wherein the at least one additive is selected from the group consisting of at least one secondary antioxidant, at least one antifoam, at least one low-temperature flow improver, and combinations thereof.

20. The oxidation-stabilized biodiesel of claim 14, further comprising at least one secondary antioxidant selected from the group consisting of alkylthiomethylphenols, hydroxylated diphenyl thioethers, phosphates, phosphonites, peroxide-destroying compounds, and mixtures thereof.

21. The oxidation-stabilized biodiesel of claim 14, further comprising at least one secondary antioxidant is selected from the group consisting of 2,4-di((octylthio)methyl)-6-tert-butylphenol, 2,4-di((octylthio)methyl)-6-methylphenol, 2,4-di((octylthio)methyl))-6-ethylphenol, 2,6-di((dodecylthio)methyl)-4-nonylphenol, 2,2′-thiobis[6-tert-butyl-4-methylphenol], 2,2′-thiobis[4-octylphenol], 4,4′-thiobis[6-tert-butyl-3-methylphenol], 4,4′-thiobis[6-tert-butyl-2-methylphenol], 4,4′-thiobis[3,6-di-sec-amylphenol], 4,4′-bis[2,6-dimethyl-4-hydroxyphenyl]disulfide, triphenyl phosphite, diphenyl alkyl phosphites, phenyl dialkyl phosphites, tris[nonylphenyl]phosphite, trilauryl phosphite, trioctadecyl phosphite, distearyl pentaerythrityl diphosphite, tris[2,4-di-tert-butylphenyl]phosphite, diisodecyl pentaerythrityl diphosphite, bis[2,4-di-tert-butylphenyl]pentaerythrityl diphosphite, bis[2,6-di-tert-butyl-4-methylphenyl]pentaerythrityl diphosphite, bis[isodecyloxy]pentaerythrityl diphosphite, bis[2,4-di-tert-butyl-6-methylphenyl]pentaerythrityl diphosphite, bis[2,4,6-tri-tert-butylphenyl]pentaerythrityl diphosphite, tristearyl sorbitol triphosphite, tetrakis[2,4-di-tert-butylphenyl]4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyldibenzo[d,g]-1,3,2-dioxaphosphocine, bis[2,4-di-tert-butyl-6-methylphenyl]methyl phosphate, bis[2,4-di-tert-butyl-6-methylphenyl]ethyl phosphate, esters of β-thiodipropionic acid, mercaptobenzimidazole, the zinc salt of 2-mercaptobenzimidazole, zinc dibutyldithiocarbamate, dioctadecyl disulfide, pentaerythrityl tetrakis[β-dodecylmercapto]propionate, and mixtures thereof.
